(19) United States
(12) Patent Application Publication
(10) Pub. No.: US 2004/0125791 A1
(43) Pub. Date: Jul. 1, 2004

(54) Method for transmitting fax data via a packet transmission network

(76) Inventor: Klaus Hoffmann, Deutschland (DE)

Correspondence Address: MORRISON & FOERSTER LLP, 1650 TYSONS BOULEVARD, SUITE 300, MCLEAN, VA, 22102, US

(21) Appl. No.: 10/415,933

(22) PCT Filed: Nov. 6, 2001
(86) PCT No.: PCT/DE01/04169

(30) Foreign Application Priority Data
Nov. 6, 2000 (DE) 10054940.3

(51) Int. Cl. H04L 12/66

(52) U.S. Cl. 370/352

(57) ABSTRACT

The invention relates to a method, whereby a transmission path for the transmission of user data is established between two fax devices (FA, FB) on a multiplexing telecommunication network (12). A section of the transmission path, lying between two network gateway units (28, 42), is in a packet transmission network (10). The type of encoding and/or transmission protocol applied in the packet transmission network (10) is changed for the transmission of fax data. On performing the change at least one exchange (48, 50) on the switching network is affected. The establishment of a protocol for the exchange of signalling messages between control units (52, 54) for the control of the network gateway units (28, 42) is thus omitted.

The invention relates to a method in which a transmission path for transmitting user data is established between two fax devices in a circuit-switched telecommunications network. A section of the transmission path, which section lies between two network gateway units, is part of a packet transmission network in which the user data is forwarded as data packets. The network gateway units are controlled by a control unit in each case.

The circuit-switched telecommunications network is, for example, a network in which the user data is routed in time slots, e.g. in the time slots of a PCM system (Pulse Code Modulation). The telephone network of Telekom AG in Germany is an example of one such network.

The packet transmission network is, for example, the Internet or a data transmission network which works in accordance with the Internet protocol. However, other packet transmission networks are also used, e.g. ATM networks (Asynchronous Transfer Mode). In an ATM network, the data packets are also designated as cells. The data packets or cells contain routing information which is used for forwarding the user data contained in the data packets.

The ITU-T (International Telecommunication Union—Telecommunication Standardization Sector) has determined the following standards for the transmission of fax data:

T.30 (July 1996) “Procedures for document facsimile transmission in the general switched telephone network”, and

the T.38 standard (June 1998) “Procedures for real-time Group 3 facsimile communication over IP networks”, which is based on the above standard.

The network gateway units are gateways, for example, as explained in the H.323 standard of the ITU. Control units are used for controlling the network gateway units. If the control units are remote from the network gateway units, i.e. separated by significant distances, control protocols are then used. An example of such a control protocol is the MGCP protocol (Media Gateway Control Protocol), which is specified in the de facto RFC 2705 standard of the IETF (Internet Engineering Task Force). However, this standard does not specify how signaling data should be exchanged between the control units for the network gateway units.

The invention addresses the problem of specifying a method for transmitting fax data via a packet transmission network, which method allows a transmission of voice data and fax data having different coding types and/or different transmission protocols. In particular, voice data is to be transmitted with low transmission capacity. Associated units and an associated program are also to be specified.

The problem addressed by the method is solved by the method steps specified in Claim 1. Developments are specified in the dependent claims.

In the method according to the invention, in addition to the method steps cited at the beginning, an initial coding type and an initial transmission type are first selected for the user data which is transmitted. After the detection of a fax tone which is typical for fax devices, a fax data coding type and/or a fax transmission protocol is selected for the user data which is transmitted in the data packets. In order to set the fax coding type and/or the fax transmission protocol, signaling data is transmitted from the one network gateway unit, via its control unit, via at least one exchange of the circuit-switched network to the other network control unit and then to the other network gateway unit.

This measure has the result that voice data and fax data can be transmitted in accordance with different coding types and/or different transmission protocols. Since it is not known at the start of a connection between the two fax devices that fax devices are involved, the initial coding and the initial, transmission protocol are selected as a precaution. The initial coding type and the initial transmission protocol are suitable for the transmission of voice data. If the fax tone is then recognized, it is necessary to switch to the fax data coding type and/or the fax transmission protocol. When switching, signaling data must be exchanged between the network gateway units. Because there is no protocol for the transmission of signaling data between the network gateway units and there is no protocol for transmitting signaling data between the control units of the network gateway units, and because the realization of such a protocol would require additional implementation expense, a conventional exchange is used for transmitting the signaling data. This allows signaling data to be exchanged between the network gateway units without the need to develop and implement a new protocol. Only adaptations are required to a protocol which already exists and is therefore proven in practice.

It is possible to change only the coding type, e.g. from G.723.1 to G.711. The same protocol, e.g. the RTP protocol, is used as a fax transmission protocol at a lower protocol level in the case of both voice data and fax data. In a second possibility, only the transmission protocol is changed, e.g. from RTP to T.38, TCP or UDP. The coding type for the transmission of voice data and fax data is the coding type according to the G.711 standard. In a third possibility, the coding type and the transmission protocol are changed.

In a development of the method according to the invention, the use of the initial coding type results in a compressing or decompressing the user data at the gateway between the telecommunications network and the packet transmission network. This measure makes it possible to compress voice data. In contrast, the fax coding type does not result in any compressing or decompressing of the user data, or results in a different compressing or a different decompressing of the user data from the initial coding type. Fax data is not generally compressed, because the signaling tones of the fax devices cannot reliably be recognized in the partner fax device otherwise. If the fax tones are not reliably recognized, errors occur during connection setup, which errors can lead to an abandonment of the connection setup.

In the development, the initial transmission protocol alternatively or cumulatively receives synchronization data which marks the sampling instants of a voice signal. This measure ensures that, in the absence of the fax tone, i.e. during the transmission of voice data, the voice data can be synchronized again on the side of the receiving terminal, despite the asynchronous transmission of the voice data in the section of the packet transmission network. A high voice quality can be achieved because it is possible to synchronize the voice signal which is to be output. Indeed, even the smallest variations in the synchronization would lead to a considerable decrease in voice quality. In contrast, the fax transmission protocol in a configuration does not contain any synchronization data which marks sampling instants. When transmitting fax data, only the sequence of said data is significant for the emerging image, but not the instant at which this data is printed onto a medium. By dispensing with synchronization data in the fax transmission protocol, this protocol is simple and requires a lower transmission quality.

In a further development, the initial coding type is the coding type established by the ITU-T in the G.723.1 standard “Dual Rate Speech Coder for Multimedia Communications Transmitting at 5.3 and 6.3 Kilobits per Second”. Compared with the coding type which is otherwise used for the transmission of voice data and fax data, which coding type is specified in G.711 “Pulse Code Modulation (PCM) of Voice Frequencies” and has a transmission rate of 64 kilobits per second, the required transmission rate falls by a factor of approximately 10. The coding type specified in the cited G.711 standard is used alternatively or cumulatively for the fax data coding type.

In a configuration of the development, the initial transmission protocol is the RTP protocol (Real Time Protocol), which is specified in the de facto RFC 1889 and RFC 1890 standards of the IETF (Internet Engineering Task Force). In a configuration, the fax transmission protocol is the UDP protocol (User Datagram Protocol) or the TCP protocol (Transmission Control Protocol), which are specified in the de facto RFC768 and RFC793 standards respectively. By using the UDP or TCP protocols, the T.38 standard of the ITU-T can be supported with regard to the transmission protocol of a lower protocol level. Alternatively or cumulatively, the fax transmission protocol is the T.38 protocol, i.e. all protocol levels then comply with this standard.

In a further development, the signaling data is transmitted between two exchanges. The signaling data is transmitted between the exchanges using transport elements and a transport protocol in accordance with the ISUP standard of the ITU-T. The ISUP standard contains the following standards:

Q.761 (December 1999) “Signalling System No. 7—ISDN user part functional description”,

Q.762 ( ) “Signalling System No. 7—ISDN user part general function of messages and signals”,

Q.763 (1997) “Signalling System No. 7—ISDN user part formats and codes”, and

Q.764 (September 1997) “Signalling System No. 7—ISDN user part signalling procedures”.

The aforementioned standards form the core of the ISUP protocol. By supporting these standards, exchanges can be used which need only minor modification or no modification in comparison with commercially available exchanges. Alternatively, the signaling data is transmitted between the two exchanges using transport elements and a transport protocol in accordance with the BICC standard Q.1901 “Bearer Independent Call Control Protocol” of the ITU-T. Conventional exchanges require more extensive modification if this standard is used, for example the central CIC (Circuit Identification Code) must be lengthened from two bytes to four bytes. However, the standardization of the BICC standard is almost complete, and therefore a standard is used which will quickly spread.

In a further development, whether using the ISUP standard or the BICC standard, transport elements are supported in accordance with the Q.763 Add. 1 standard, e.g. the Container APP (Application Transport Parameter), and transport protocols in accordance with the Q.765 standard “Revised Recommendation Q.765 (Application Transport Mechanism)”. In particular, the Q.765.5 standard “Application Transport Mechanism—Bearer Independent Call Control” is used. Although the last cited standard Q.765.5 was specified for the BICC standard, it can also be used in the case of the ISUP standard. The transport elements are used for transporting signaling data which does not relate to the switching in the circuit-switched network and is therefore network-external from the standpoint of this network. The transport elements and transport protocols can thus be used for transporting the signaling messages for the section which is located in the packet transmission network. The Q.765.5 standard also refers to BAT (Bearer Associated Transport) in this context.

In a development, the transport element specified in the Q.765.5 standard, section 11.1.7 “Single Codec” is used. A different code to that of the ITU-T is used as an organization code. This is in any case so until such time as the method in accordance with the invention has become part of the standard. In the transport element “Codec Information”, see the Q.765.5 standard, section 11.1.7.2 and the following subsections, a value is specified which is not yet included in the standard, which value designates the coding type in accordance with the standard for the transmission of fax data, in particular the coding type T.38.

In a further development, both control units are arranged in an exchange. A signaling protocol which has been specified for the exchange is used for transmitting the signaling data between the control units. For example, the internal signaling protocol of the Siemens EWSD exchange (digital electronic switching system) follows the ISUP standard very closely. The internal signaling protocol contains equivalent messages for most of the signaling messages of the ISUP standard. In a configuration, at least some of the messages of the internal signaling protocol are used for signaling to various interface units which are used for connecting e.g. subscribers, other exchanges or the control units. Such messages relate, for example, to the connection setup and the connection cleardown between the aforementioned units within the exchange.

In a development of the method in accordance with the invention, the network gateway unit is physically remote from the control unit which controls it. For example, the network gateway unit and control unit are located several hundred kilometers apart. In a configuration, a standardized protocol or a de facto standardized protocol is used for signaling between network gateway unit and control unit. The aforementioned MGCP protocol (Media Gateway Control Protocol) in accordance with RFC 2705, a protocol in accordance with the ITU-T H.248 standard, or another suitable protocol is therefore used.

In a configuration of the development, the control unit sends a connection setup message to the network gateway unit, in which message the initial coding type is specified, preferably the coding type in accordance with the G.723.1 standard. In addition, the connection setup message, e.g. in accordance with RFC 2705, contains an element which contains a request for the detection and reporting of the fax tone. Because the request is included in the connection setup message, it is not necessary to generate a separate message for the request. Consequently, less transmission capacity is required for the connection setup.

In a further development, after detecting the fax tone, a control unit sends a connection modification message to the network gateway unit which it controls, in which message the fax coding type and/or the fax data transmission protocol is explicitly or implicitly specified, preferably by means of a reference to the T.38 standard. The coding type and the transmission protocol are then changed when the connection modification message is processed. Connection parameters of the remote side can already be transferred in the connection modification message.

The invention also relates to an exchange, a network gateway unit and a control unit for the network gateway unit. The aforementioned units are constructed in such a way that they are suitable for use in the method in accordance with the invention or in one of its developments. The exchange is therefore particularly suitable for forwarding the signaling data required for switching the coding type or the transmission protocol. The network gateway unit is able to transmit the aforementioned messages, in particular such messages as are not yet included in a standard. The aforementioned technical effects also apply to the units.

The invention also relates to a program having an instruction sequence which, when executed by a processor, carries out the method in accordance with the invention, or carries out one of the developments of said method. The aforementioned technical effects also apply to the program.

Exemplary embodiments of the invention are explained below with reference to the attached drawings in which:

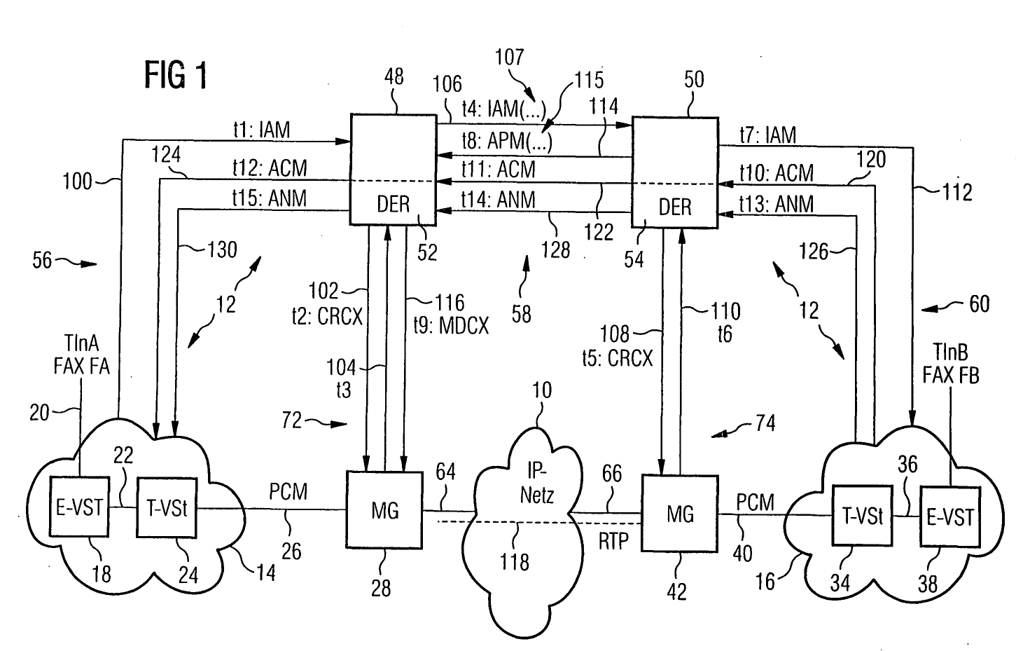

FIG. 1 shows a telephone network which is connected to the Internet, and signaling messages being exchanged for the purpose of establishing transmission paths in the connected networks,

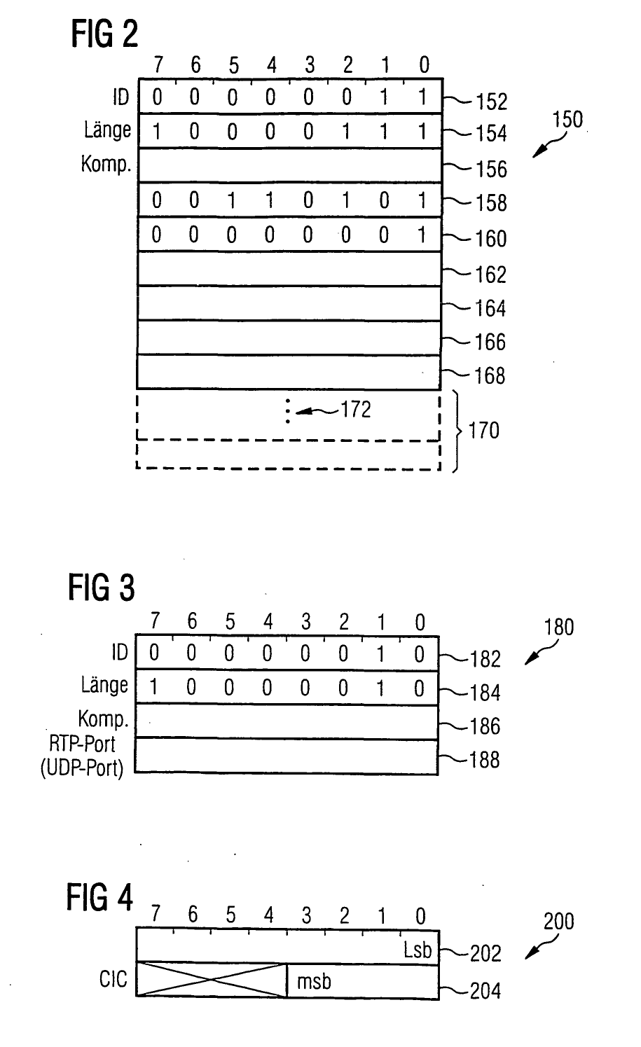

FIG. 2 shows the structure of an information element for transmitting an IP address,

FIG. 3 shows the structure of an information element for transmitting an RTP or UDP port number, and

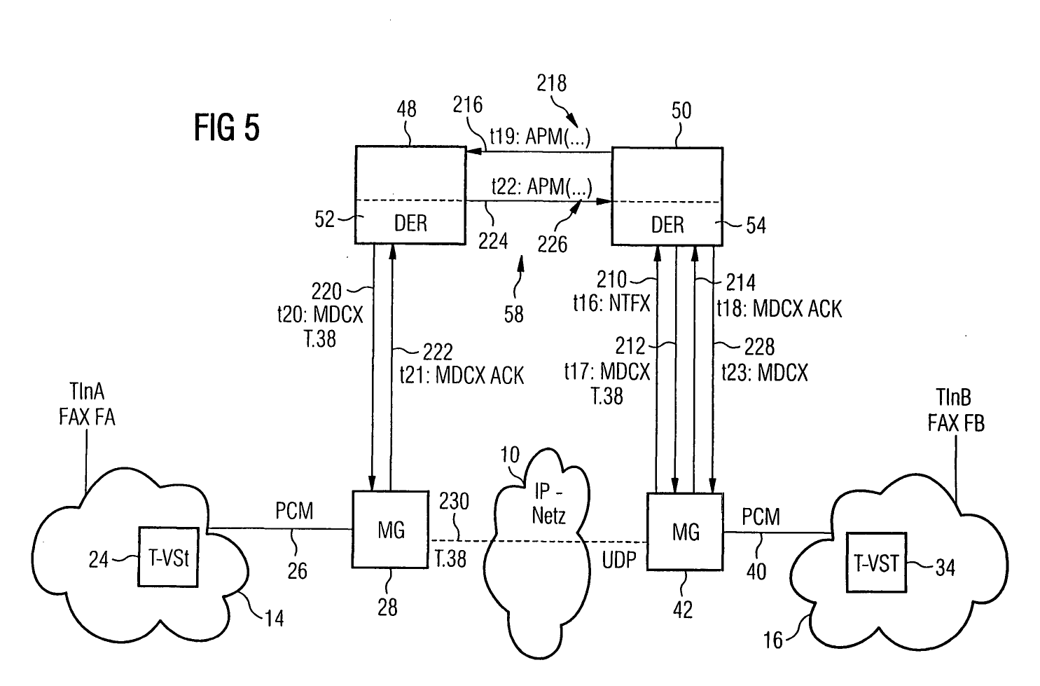

FIG. 4 shows the structure of a code element for designating the call entity,

FIG. 5 shows signaling messages which are exchanged when a fax tone is detected, and

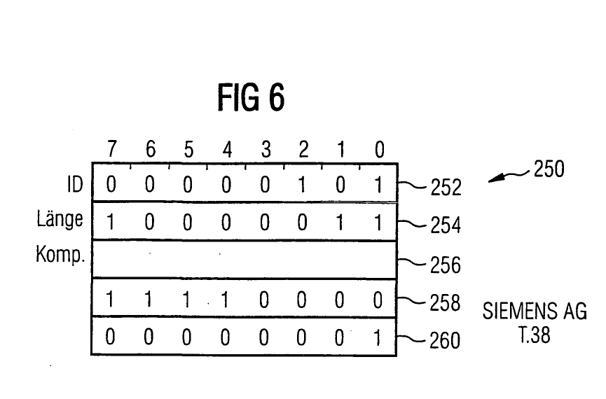

FIG. 6 shows the structure of an information element for transmitting a code for the transmission of fax data.

FIG. 1 shows a telephone network 12, e.g. the telephone network of Telekom AG in Germany, which is connected to the Internet 10. Two parts 14 and 16 of the telephone network 12 are illustrated in FIG. 1. The part 14 is located, for example, in southern Germany and the part 16 in northern Germany. A local exchange 18 is illustrated in the part 14, to which local exchange a fax device FA of a subscriber TlnA is attached via a transmission line 20, e.g. via an ISDN connection interface (Integrated Services Digital Network). The local exchange 18 is connected to a transit exchange 24 via an interexchange line 22. The transit exchange 24 is, for example, a conventional exchange of the type EWSD (digital electronic switching system) manufactured by the company Siemens AG. A transmission link 26 leads from the transit exchange 24 to a network access unit 28. The transmission link 26 is, for example, a channel of a PCM-30 system (Pulse Code Modulation) as is otherwise used for transmitting voice data between different exchanges. The PCM method uses the CODEC G.711. The connections between different exchanges are designated as trunks. The function of the network access unit 28 is explained further below.

The part 16 of the telephone network 12 contains a transit exchange 34, e.g. of the type EWSD. The transit exchange 34 is connected via an interexchange line 36 to a local exchange 38, to which a fax device FB of a subscriber TlnB is attached. A transmission link 40 of the transit exchange 34 leads to a network access unit 42. The transmission link 40 is, for example, a PCM channel as is normally used for transmitting voice data between exchanges. The function of the network access unit 42 is explained further below

The telephone network 12 also contains two exchanges 48 and 50, which are developments of the exchanges of the type EWSD. In addition to the functions of an exchange of the type EWSD, the exchanges 48 and 50 also assume the functions of service providing computers 52 and 54. These additional functions are likewise explained further below with reference to FIG. 1. A signaling connection 56 can be established between the exchange 58 and the transit exchange 24, on which signaling connection are transmitted signaling messaaes in accordance with the ISUP protocol (ISDN User Part). Examples of messages of this protocol are explained below with reference to FIG. 1.

A signaling connection 58 can be established between the exchanges 48 and 50. The signaling messages via this signaling connection are likewise transmitted in accordance with the ISUP protocol. Information elements are transmitted in a container APP (Application Associated Parameter) in accordance with the Q.765 Add. 1 standard (June 2000). These information elements are explained below with reference to FIGS. 2 and 3.

A signaling connection 60 can be established between the exchange 50 and the transit exchange 34, on which signaling connection are transmitted signaling messages in accordance with the ISUP protocol.

Both the telephone network 12 and the Internet 10 are used for transmission of the voice data between the subscriber TlnA and the subscriber TlnB or of the fax data between the fax devices FA and FB. The voice data or fax data is transmitted in a circuit-switched manner in voice channels within the telephone network 12. By contrast, the voice data or fax data is transmitted in data packets within the Internet 10.

Voice data or fax data, which is received in voice channels in each case, is divided into data packets in the network access units 28 and 42 and forwarded into the Internet 10. Data packets which arrive from the Internet 10 and contain voice data or fax data are unpacked in the network access units 28 and 42 and forwarded into voice channels in the telephone network 12. The network access unit 28 or 42 is connected to the Internet 10 via a transmission link 64 or 66 respectively. Data packets can therefore be exchanged between the network access units 28 and 42 via the Internet 10. The service providing computers 52 and 54 are also connected to the Internet 10. Consequently, data packets can also be exchanged between the service providing computers 52 or 54 and the network access units 28 and 42, see signaling path 72 or 74 between the service providing computer 52 and the network access unit 28, and between the service providing computer 54 and the network access unit 42 respectively. The network access units 28 and 42 and the service providing computers 52 and 54 each have at least one Internet address via which they can be addressed in the Internet 10.

The following explains signaling messages for establishing a connection for transmitting fax data or voice data between the subscriber TlnA and the subscriber TlnB. When establishing a voice connection between the subscriber TlnA and the subscriber TlnB or a fax connection between the fax devices FA and FB, the transit exchange 24 generates a connection setup message 100 at an instant t1 in accordance with the protocol, which message is also called IAM message (Initial Address Message). This message contains inter alia the full call number of the subscriber TlnB in the telephone network 12 and the number of a time slot to be used for the transmission on the transmission link 26. The connection setup message 100 is transmitted via the signaling connection 56. After the connection setup message 100 is received, a program is executed in the exchange 48, it being confirmed during said execution that the Internet 10 can be used for transmitting the fax data or the voice data. It is determined that the network access unit 28 can be used as an interface between telephone network 12 and Internet 10 on the side of the subscriber TlnA. The service providing computer 52 is instructed by a control unit of the exchange 48 to carry out the steps required for this.

At an instant t2 which is subsequent to the instant t1, the service providing computer 52 sends a connection setup message 102 in accordance with the de facto RFC 2705 standard to the network access unit 28 via the signaling path 72. The connection setup message 102 is designated as a CRCX message (Create Connection). The time slot which is to be used for the user data transmission is specified in the connection setup message 102. In addition, the method in accordance with the G.723.1 standard, for example, is specified as the CODEC (Coding/Decoding). The network access unit 28 processes the connection setup message 102 and generates in reply a reply message 104 at an instant t3. The reply message 104 confirms the receipt of the connection setup message 102 and contains inter alia an Internet address and a port number, which can be used for the receipt of user data for an RTP connection to be established between the network access unit 28 and the network access unit 42, and which is now assigned to the time slot. The RTP connection is suitable for transmitting voice data and is established as a precaution, since it is not yet possible at the instant of the connection setup to confirm whether fax data or voice data is to be transmitted.

The service providing computer 52 receives the reply message 104 and forwards the Internet address and the port number which are received to the control unit of the exchange 48. The control unit of the exchange 48 processes the connection setup message 100 in accordance with the ISUP protocol and generates a connection setup message 106 at instant t4. The connection setup message 106 is also designated as an IAM message (Initial Address Message) in accordance with the ISUP protocol. The connection setup message 106 includes two information elements, which are explained in greater detail below with reference to FIGS. 2 and 3, and in which the Internet address and the port number are forwarded, see point 107. These information elements are not specified in the ISUP standard, but are transmitted via the signaling connection 58 in a manner which complies with the ISUP standard.

The exchange 50 receives the connection setup message 106 and also processes the information elements contained therein. On the basis of the content of these information elements or with reference to the code (CIC—Circuit Identification Code) for designating the call entity, it is recognized that the telephone connection to be established is not a normal telephone connection but a telephone connection which includes use of the Internet 10. The exchange 50 determines the network access unit 42 as the network access unit to be used on the side of the subscriber TlnB. The exchange 50 also specifies a time slot, which must be used in the case of exclusively circuit-switched transmission of the user data between the exchanges 50 and 34. This time slot designates a transmission channel of the transmission link 40.

The service providing computer 54 is instructed by the control unit of the exchange 50 to establish an Internet connection via the signaling path 74. The service providing computer 54 sends a connection setup message 108 to the network access unit 42 at an instant t5. The connection setup message 108 corresponds to the aforementioned de facto RFC 2705 standard and is also designated as a CRCX message (Create Connection). The message 108 contains the Internet address, which was sent by the network access unit 28 via the exchange 48, and the port number, which are to be used for setting up a connection, said connection being an RTP connection as a precaution because voice data is mostly transmitted. The connection setup message 108 also specifies the time slot which is determined by the exchange 50 and the CODEC G.723.1. The connection setup message 108 also contains a data field in which the recognition in the network access unit 42 of a fax tone having the frequency of 2100 Hz is requested, see RFC 2705, section 3.4, “Formal description of the protocol”, RequestedEvents, requestedEvent, eventname, packageName, and section 6.1.1, “Generic Media Package”, parameter ft “fax tone” in conjunction with the parameter R “Request”. Alternatively, the request can be made using a separate notification request message (notification request).

During processing of the connection setup message 108 in the network access unit 42, an Internet address and an as yet unassigned port number of the network access unit 42 are determined for the specified time slot, which Internet address and port number can be used for the receipt of the user data packets from the network access unit 28. The network access unit 42 subsequently sends a reply message 110 at an instant t6, in order to confirm the receipt of the connection setup message 108. The reply message 110 also contains the Internet address which has been determined for the network access unit 42 and the port number which has been determined.

The remaining part of the connection setup message 106 is processed in the exchange 50 in accordance with the ISUP protocol. In this case, a connection setup message 112 is generated, said message being transmitted to the transit exchange 34 via the signaling connection 60. The connection setup message 112 is also designated as an IAM message (Initial Address Message). The connection setup message 112 contains inter alia the call number of the subscriber TlnB and the time slot which is preset by the exchange 50. The connection setup message 112 is processed in the transit exchange 34 in accordance with the protocol and is forwarded to the local exchange 38. The local exchange 38 calls the subscriber TlnB or the fax device FB.

During processing of the connection setup message 106 after receipt of the reply message 110, a reply message 114 which is also designated as an APM message (Application Transport Message) in accordance with the ISUP protocol is generated in the exchange 50. The reply message 114 includes an information element containing the Internet address of the network access unit 42 and an information element containing the RTP port number which was transferred from the network access unit 42, see point 115. The reply message 114 is transmitted to the exchange 48 at an instant t8.

The control unit of the exchange 48 extracts the Internet address and the port number from the reply message 114, and instructs the service providing computer 52 to forward these connection parameters to the network access unit 28. For this purpose, the service providing computer 52 sends a modification message 116 in accordance with the de facto RFC 2705 standard at an instant t9. The modification message 116 is also designated as an MDCX message (Modify Connection). The modification message 116 contains the Internet address of the network access unit 42 and the port number of the network access unit 42, which port number is to be used for the RTP connection that is to be established as a precaution.

The modification message 116 is processed in the network access unit 28 in such a way that a direct transmission path 118 can be used for transmitting user data between the network access units 28 and 42 in accordance with the RTP protocol and CODEC G.723.1. FIG. 1 does not illustrate a reply message generated by the network access unit 28 in response to the modification message 116.

At a subsequent instant t10, the transit exchange 34 generates a message 120 in accordance with the protocol, which message is also designated as an ACM message (Address Complete Message), and signals that all selection digits have been transmitted in order to connect the subscribers TlnA and TlnB or the fax devices FA and FB. The message 120 is processed by the control unit of the exchange 50 in accordance with the protocol. The exchange 50 sends an ACM message 122 in accordance with the ISUP protocol to the exchange 48 at an instant t11. The exchange 48 processes the ACM message 122 and in turn sends an ACM message 124 to the transit exchange 24.

If the fax device FB of the subscriber TlnB answers, this is signaled to the transit exchange 34 in accordance with the ISUP protocol. The transit exchange 34 generates a reply message 126 at instant t13, which reply message is transmitted to the exchange 50 via the signaling connection 60. The reply message 126 is also designated as an ANM message (Answer Message). Charges start to apply as a result of this message.

The reply message 126 is processed in the exchange 50 in accordance with the protocol. In this case, a reply message 128 is sent to the exchange 48. As a result of the reply message 128, the exchange 48 generates a reply message 130 to the transit exchange 24 at an instant t15.

The inband signaling data generated by the fax device FB of the subscriber TlnB is transmitted in time slots and in accordance with CODEC G.711 in the part 16 of the telephone network 12 and via the transmission link 40. Operations following the detection of the fax tone sent by fax device FB are explained below with reference to FIG. 5.

FIG. 2 shows the structure of an information element 150 for transmitting an Internet address. In a first exemplary embodiment, the information element 150 contains nine consecutive data fields 152 to 168, each of which has a length of eight bits, i.e. one byte. Bit positions 0 to 7 are located from right to left in this sequence. A code (Interworking Function Address) for identifying the information element 150 is transmitted in the data field 152. The code has the value 3 to show that the information element 150 is used for transmitting an Internet address.

The length of the information element 150, minus the data fields 152 and 154, is specified in a data field 154. In the exemplary embodiment, the value Seven is stored in binary format in the data field 154, see also the Q.765.5 standard, section 11.1.1.

A compatibility information is transmitted in the data field 156, the value of which compatibility information indicates to the recipient what to do if the recipient cannot fully process the information element 150, see also the Q.765.5 standard, section 11.1.1.

An authorization and format code is transmitted in the data field 158, said code having the value “35” in hexadecimal notation. This value is used as a reference to the Internet protocol in accordance with the ITU standard X.213 Appendix A.

A code having the value one is stored in the data field 160 if an Internet address in accordance with Internet protocol version 4 is transmitted. The four bytes of the Internet address in accordance with version 4 of the Internet protocol are transmitted in the subsequent data fields 162 to 168.

However, if an Internet address in accordance with Internet protocol version 6 is to be transmitted using the information element 150, there is a variation in the length specification, see data field 154, and a variation in the data field 160. The value zero is transmitted in the data field 160 when transmitting Internet addresses in accordance with the Internet protocol version 6. In this case, sixteen data fields 162 to 170 are attached to the data field 160 and store the 16 bytes of the Internet address in accordance with the Internet protocol version 6, see also point 172.

FIG. 3 shows the structure of an information element 180 for transmitting an RTP, UDP or TCP port number. The information element 180 contains four data fields 182 to 188, each of which is one byte in length. The significance of the data fields 182 to 186 corresponds in this sequence to the significance of the data fields 152 to 156 of the information element 150. The value Two is transmitted in the data field 182, in order to identify the information element 180 as an information element for transmitting a port number. In contrast with the function performed here, the code transmitted in data field 182 is designated as a “backbone network connection identifier” in the Q.765.5 standard, section 11.1.4. The value Two is transmitted in a data field 184 as the length of the information element 180 minus the data fields 182 and 184. An information for compatibility is transmitted in data field 186. The port number to be transmitted, i.e. the port number to be used in the network access unit 28 or in the network access unit 42 for the RTP connection, is then transmitted in the data field 188, see FIG. 1.

FIG. 4 shows the structure of a code element 200 which is used for designating call entities between the exchanges 48 and 50. The structure of the code element 200 is specified in the standard Q.763, section 1.2. The code element 200 contains two data fields 202 and 204, each having a length of one byte. The number of the entity is transmitted starting with the least significant bit in the data field 202, see bit position 0, through to bit position 7 of the data field 202 and then continuing between the bit positions 0 to 3 of the data field 204. The bit positions 4 to 7 of the data field 204 are not used for designating the entity. The code element 200 has no further data fields.

FIG. 5 shows the signaling messages which are exchanged when the fax tone emitted by the fax device FB is detected. After the detection of the fax tone, the network access unit 42 sends a notification message 210 to the exchange 50 at an instant t16. The notification message 210 is designated as an NTFX message (notification) in accordance with the MGCP protocol. The notification message 210 is initially processed in the service providing computer 54.

In response to the notification message 210, the service providing computer 54 sends a connection modification message 212 to the network access unit 42 at an instant t17, which connection modification message is also designated MDCX message and specifies a code which refers to the T.38 standard as a transmission protocol for the modified connection. The code is specified, for example, in a field which is designated CODEC or “compressionAlgorithm”, see RFC 2705, section 3.4, “Formal syntax description of the protocol”, “LocalConnectionsOptions”. The character string “T38” is specified, for example, to indicate the type of the character string “PCM A” for G.711 in accordance with the RFC 1889 and RFC 1890 standards.

As a result of the code indicating the T.38 standard in the connection modification message 212, a CODEC as permitted by the T.38 standard is selected in the network access unit 42 for the UDP connection which is to be established, e.g. the CODEC G.711.

After the connection modification message 212 is received, the network access unit 42 determines an Internet address and a port number for a UDP connection (User Datagram Protocol) on the basis of the reference. The Internet address and the port number are sent to the service providing computer 54 at an instant t18 in a reply message 214, which is also designated as an MDCX-ACK message. In the reply message 214, a code with the value “90” is used for specifying the CODEC or identifying the compression algorithm, which is freely selectable in accordance with the de facto RFC 1890 standard.

The service providing computer 54 forwards the Internet address and the port address, as contained in the reply message 214, via an internal signaling protocol of the exchange 50 to an interface unit for connecting the signaling connection 58. This interface unit generates an APM message 216, which is sent via the signaling connection 58 to the exchange 48 at an instant t19. The APM message 216 contains transport elements 218 which have the same structure as the information elements 150 and 180. The Internet address, which was transferred by the network access unit 42 for the UDP connection, and the UDP port number, are transmitted in the transport elements. The message 216 also contains an information element “Action Indicator”, as specified in the Q.765.5 standard, section 11.1.3. The value “00001011” (Modify Codec) is transmitted in this transport element. The message 216 also contains a transport element 250, which is explained below with reference to FIG. 6. The transport element 250 is used to request the switch to the transmission protocol type in accordance with the T.38 standard, i.e. in particular the transmission protocol UDP, and to the coding/decoding type permitted by the T.38 standard, e.g. in accordance with G.711.

The exchange 28 receives the message 216 and forwards the signaling data contained therein to the service providing computer 52 by means of internal signaling messages.

At an instant t20, the service providing computer 52 sends a connection modification message 220, which is also designated as an MDCX message, to the network access unit 28. The connection modification message 220 contains the Internet address and port number to be used for the UDP connection which is to be setup. Also specified in the connection modification message 220, as a CODEC or code for the compression algorithm, is a code which indicates the T.38 standard.

During processing of the connection modification message 220 in the network access unit 28, an Internet address to be used for the connection and a port number are established. As a result of the reference to the T.38 standard, the switch is made to a coding type as permitted by the T.38 standard, e.g. G.711, and to the UDP transmission protocol. The Internet address of the network access unit 28 and the port number which is determined are transferred in a reply message 222 from the network access unit 28 to the service providing computer 52 at an instant t21. As a CODEC or code for the compression algorithm, the reply message 222 contains a proprietary code which indicates the T.38 standard. The code has the value “90”, for example, said value being freely selectable in accordance with the de facto RFC 1890 standard.

The service providing computer 52 forwards the Internet address and port number, which are contained in the reply message 222, to the exchange 48, which exchange sends an APM message 224 to the exchange 50 at an instant t22. The message 224 contains transport elements which are structurally identical to the information elements 150 and 180, but which contain the Internet address and UDP port number determined in the network access unit 28. In addition, a transport element “Action Indicator” in accordance with the Q.765.5 standard, section 11.1.3, and the value “00001100” specified therein, are used to signal that it was possible to switch the CODEC successfully. The exchange 50 forwards the Internet address and port number contained in the message 224 to the service providing computer 54. At an instant t23, the service providing computer 54 generates a connection modification message 228, which is also designated as an MDCX message, containing the Internet address and UDP port number which were transferred a short time previously. The data to be used for the UDP connection is therefore known in the network access unit 42. The time slot on the transmission link 40, which time slot is used for connecting the fax devices FB and FA, is now assigned to the UDP connection. In the same way, the time slot which is used for the connection between the fax devices FB and FA is assigned to the new UDP connection in the network access unit 28. The fax tone coming from the fax device FB is therefore transmitted via the transmission link 40, the UDP connection 230 and the transmission link 26 to the fax device FA. The transmission of the fax data in the Internet 10 takes place in accordance with the T.38 standard, i.e. in particular using the error correction method specified in this standard. The network access units 28 and 42 therefore work in accordance with the T.38 standard.

FIG. 6 shows an information element 250 which belongs to the transport element 218. The information element 250 is used for signaling a new CODEC and is structured in accordance with a slight modification of the Q.765.5 standard. The information element 250 contains five data fields 252 to 260 for transmitting one byte in each case. The first three data fields 252, 254 and 256 have the same function as the first three data fields in the information elements 150 and 180. The value “00000101”, to which the information element “Single Codec” is assigned, is specified in the data field 252 as a code, see the Q.765.5 standard, section 11.1.2.

The data field 254 contains the value “10000011”, in order to indicate that the data field 254 is followed by three further data fields. The data field 256 is used for transmitting the compatibility information as specified in the Q.765.5 standard, section 11.1.1, in particular FIG. 9.

The value “11110000” is specified as an organization code in the data field 258, in order to indicate Siemens AG. Until now, this value is not yet used in section 11.1.7.1 of the Q.765.5 standard. Consequently, the value “11110000” or another value indicating Siemens AG or a value indicating another company would have to be included in the Q.765.5 standard, section 11.1.7.1. Until this takes place, the assignment of the data field 258 is proprietary.

The value “00000001” is specified in the data field 260, in order to indicate the T.38 standard. The Q.765.5 standard can also be extended with reference to this value. A section 11.1.7.2.2 would have to be inserted for the Siemens AG organization, in which section the T.38 standard is assigned to the value “00000001”.

In another exemplary embodiment, an ATM network (Asynchronous Transfer Mode) is used instead of the Internet 10. The signaling is executed in accordance with the BICC standard. An information element comprising four bytes is then used instead of the information element 200. However, the signaling operations as explained with reference to FIG. 5 remain essentially identical.

Instead of the ISUP standard, the BICC standard is applied to signaling for the transmission of voice data or fax data in an IP network (Internet protocol). The other operations take place as explained above with reference to FIGS. 1 to 5.

Before transmission of the fax data, any voice-pause suppression, echo suppression and/or data compression that may have been activated is switched off by means of control messages in accordance with the MGCP protocol. Consequently, the transmission of the fax data is not compromised by the aforementioned functions.

1. A method for transmitting fax data via a packet transmission network (10), in which method a transmission path for transmitting user data is established between two fax devices (FA, FB) in a circuit-switched telecommunications network (12), a section (118, 230) of the transmission path, which section lies between two network gateway units (28, 42), is located in a packet transmission network (10) in which the user data is forwarded as data packets, the network gateway units (28, 42) are controlled by a control unit (52, 54) in each case, an initial coding type and an initial transmission protocol which are suitable for the transmission of voice data are initially selected for the user data to be transmitted in the data packets, after the detection of a fax tone which is typical for fax devices (FA, FB), a fax data coding type and/or a fax transmission protocol is selected for the user data to be transmitted in the data packets, and in which method, for setting the fax coding type and/or the fax transmission protocol, signaling data travels from one network gateway unit (28, 42), via its control unit (52, 54), via at least one exchange (48, 50) of the circuit-switched network (12) to the other control unit (52, 54) and then to the other network gateway unit (28, 42).

2. The method as claimed in claim 1, characterized in that the initial coding type results in a compressing or decompressing of the user data at the gateway between the networks (10, 12), and/or that the fax data coding type does not result in any compressing or decompressing of the user data, or results in a different compressing or decompressing of the user data from the initial coding type, and/or that the initial transmission protocol contains synchronization data which marks the sampling instants of a voice signal, and/or that the fax transmission protocol does not contain any synchronization data which marks the sampling instants.

3. The method as claimed in claim 2, characterized in that the initial encoding type is the coding type specified in the G.723.1 standard or in a standard which is based on this standard, and/or that the fax data coding type is a coding type in accordance with the T.38 standard, preferably the coding type specified in the G.711 standard or in a standard which is based on this standard, and/or that the initial transmission protocol is the RTP protocol or a protocol which is based on this protocol, and/or that the fax transmission protocol is the UDP protocol, the TCP protocol or the protocol in accordance with the T.38 standard or in accordance with a standard which is based on this standard.

4. The method as claimed in one of the preceding claims, characterized in that the signaling data is transmitted between two exchanges (48, 50), that the signaling data is either transmitted between the exchanges (48, 50) using transport elements (150, 180, 250) and a transport protocol in accordance with the ISUP standard, in particular in accordance with the standard Q.761 to Q.764 or in accordance with a standard which is based on this standard, or that the signaling data is transmitted between the exchanges (48, 50) using transport elements and a transport protocol in accordance with the BICC standard or a standard which is based on this standard.

5. The method as claimed in claim 4, characterized in that the transport elements (150, 180, 250) and the transport protocol support the Q.763 Add. 1 and/or Q.765 standard or a standard which is based on these standards, in particular the Q.765.5 standard or a standard which is based on this standard.

6. The method as claimed in claim 5, characterized in that the transport element “Single Codec” is used as a transport element (250), that a different code from that of the ITU-T is preferably used as an organization code (258), and that a value is specified in the transport element (260) “Codec Information”, which value designates a standard for the transmission of fax data and/or the coding/decoding type and/or the transmission protocol in accordance with a standard for the transmission of fax data, wherein the standard for the transmission of fax data is preferably the T.38 standard or a standard which is based on this standard.

7. The method as claimed in one of the claims 1 to 3, characterized in that both control units (52, 54) are arranged in an exchange (48), and that an internal signaling protocol which has been specified for the exchange (48) is used for transmitting the signaling data, and/or that at least some of the messages of the internal signaling protocol are the same for various interface units, preferably for interface units for connecting subscribers and/or for interface units for connecting other exchanges (50) and/or for interface units for connecting the control units (52, 54).

8. The method as claimed in one of the preceding claims, characterized in that the network gateway unit (28, 42) is controlled by a control unit (52, 54) which is physically remote, preferably in accordance with a standardized protocol or a de facto standardized protocol, in particular in accordance with the MGCP protocol, in accordance with the H.248 protocol, or in accordance with a protocol which is based on one of these protocols.

9. The method as claimed in claim 8, characterized in that the control unit (52, 54) sends a connection setup message (102, 108) to the network gateway unit (28, 42), in which message the initial coding type is specified, in particular the coding type in accordance with the G.723.1 standard, in accordance with the G.711 standard, or in accordance with a standard which is based on one of these standards.

10. The method as claimed in claim 9, characterized in that the connection setup message (102, 108) contains a request for the detection and reporting a fax tone.

11. The method as claimed in one of the preceding claims, characterized in that, after the detection of the fax tone, a control unit (54) sends a connection modification message (212) to the network gateway unit (42) which it controls, in which message the fax data coding type and/or the fax data transmission protocol is specified, preferably a reference to a standard for transmitting fax data, in particular to the T.38 standard or a standard which is based on this standard, and that when processing the connection modification message (212), the network access unit (48) changes the coding type and/or the transmission protocol.

12. The method as claimed in one of the preceding claims, characterized in that the packet transmission network is the Internet or another data transmission network which works in accordance with the Internet protocol, or that the packet transmission network is an ATM network.
